(19) United States
(12) Patent Application Publication
(10) Pub. No.: US 2019/0110028 A1
(43) Pub. Date: Apr. 11, 2019

(54) METHOD FOR CORRECTING ABERRATION AFFECTING LIGHT-FIELD DATA

(71) Applicant: THOMSON LICENSING, Issy-les-Moulineaux (FR)

(72) Inventors: Thierry BOREL, Rennes (FR); Benoit VANDAME, Betton (FR); Amo SCHUBERT, Chevaigne (FR)

(21) Appl. No.: 16/087,212

(22) PCT Filed: Mar. 20, 2017
(86) PCT No.: PCT/EP2017/056573

§ 371 Date: Sep. 21, 2018

(30) Foreign Application Priority Data
Mar. 21, 2016 (EP) 16305308.5

(51) Int. Cl. H04N 9/04; H04N 5/357; H04N 13/271; H04N 13/232

(52) U.S. Cl. CPC H04N 9/04517; H04N 13/232; H04N 13/271; H04N 5/3572

(57) ABSTRACT

The invention pertains to a method for correcting aberration affecting light-field data (LF) acquired by a sensor of a plenoptic device, said method comprising: determining (S2) a plurality of subsets of light-field data (Sub_LF) among said light-field data (LF), as a function of a physical and/or geometrical property of said light-field data, said property being a discrimination criterion associated with said aberration, projecting (S3) at least some of said subsets of light field data (Sub_LF) into respective refocused sub-pictures (Sub_Pict), as a function of: ∘spatial information about a focalization plane and, ∘a respective disparity dispersion (D(W)) resulting from said aberration, obtaining a corrected picture (Cor_Pict) from a sum (S4) of said refocused sub-pictures (Sub_Pict).

### 1. TECHNICAL FIELD

The field of the disclosure relates to light-field imaging. More particularly, the disclosure pertains to technologies for correcting aberration induced by the main lens of a camera.

### 2. BACKGROUND ART

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Conventional image capture devices render a 3 (three)-dimensional scene onto a two-dimensional sensor. During operation, a conventional capture device captures a two-dimensional (2D) image representing an amount of light that reaches each point on a sensor (or photo-detector) within the device. However, this 2D image contains no information about the directional distribution of the light rays that reach the sensor (may be referred to as the light-field). Depth, for example, is lost during the acquisition. Thus, a conventional capture device does not store most of the information about the light distribution from the scene.

Light-field capture devices (also referred to as “light-field data acquisition devices”) have been designed to measure a four-dimensional (4D) light-field of the scene by capturing the light from different viewpoints of that scene. Thus, by measuring the amount of light traveling along each beam of light that intersects the sensor, these devices can capture additional optical information (information about the directional distribution of the bundle of light rays) for providing new imaging applications by post-processing. The information acquired/obtained by a light-field capture device is referred to as the light-field data. Light-field capture devices are defined herein as any devices that are capable of capturing light-field data.

Among the several existing groups of light-field capture devices, the “plenoptic device” or “plenoptic camera” embodies a micro-lens array positioned in the image focal field of a main lens, and before a photo-sensor on which one micro-image per micro-lens is projected. Plenoptic cameras are divided up in two types depending on the distance d between the micro-lens array and the sensor. Regarding the “type 1 plenoptic cameras”, this distance d is equal to the micro-lenses focal length f (as presented in the article “Light-field photography with a hand-held plenoptic camera” by R. Ng et al., CSTR, 2(11), 2005). Regarding the “type 2 plenoptic cameras”, this distance d differs from the micro-lenses focal length f (as presented in the article “The focused plenoptic camera” by A. Lumsdaine and T. Georgiev, ICCP, 2009). For both type 1 and type 2 plenoptic cameras, the area of the photo-sensor under each micro-lens is referred to as a microimage. For type 1 plenoptic cameras, each microimage depicts a certain area of the captured scene and each pixel of this microimage depicts this certain area from the point of view of a certain sub-aperture location on the main lens exit pupil. For type 2 plenoptic cameras, adjacent microimages may partially overlap. One pixel located within such overlaying portions may therefore capture light rays refracted at different sub-aperture locations on the main lens exit pupil.

Light-field data processing comprises notably, but is not limited to, generating refocused images of a scene, generating perspective views of a scene, generating depth maps of a scene, generating extended depth of field (EDOF) images, generating stereoscopic images, and/or any combination of these.

It has been observed that light-field data are affected by the aberration induced by plenoptic camera main lens. Such light aberration phenomenon is defined as a defect in the image of an object viewed through an optical system (e.g. the main lens of a plenoptic camera) which prevents to bring into focus all the light rays depicting a same object dot.

In order to compensate the undesirable effects of the aberration phenomenon, it is well known from the prior art to introduce additional lenses within the optical system. Such additional lenses are designed and placed within the optical system so as to correct the aberration phenomenon generated by the main lens. Nevertheless, the implementation of these solutions has the drawback of increasing significantly the complexity, weight, and thickness of the optical system.

It would hence be desirable to provide an apparatus and a method that show improvements over the background art.

Notably, it would be desirable to provide an apparatus and a method, which would allow correcting the light aberration induced by the main lens of a plenoptic device, while limiting its thickness, weight and complexity.

### 3. SUMMARY OF THE DISCLOSURE

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In one particular embodiment of the technique, a method for correcting aberration affecting light-field data acquired by a sensor of a plenoptic device is disclosed. The method comprises:
determining a plurality of subsets of light-field data among said light-field data, as a function of a physical and/or geometrical property of said light-field data, said property being a discrimination criterion associated with said aberration,
projecting at least some of said subsets of light field data into respective refocused sub-pictures, as a function of:
   spatial information about a focalization plane of a corrected picture to be obtained and,
   a respective disparity dispersion resulting from said aberration,
adding said refocused sub-pictures into the corrected picture.

In the following description, the expression “aberration” refers to a defect in the image of an object dot viewed through an optical system (e.g. the main lens of a plenoptic camera) which prevents to bring into focus all the light rays depicting a same object dot. As a consequence, these light rays converge at different focalization distances from the main lens to form images on different focalization planes, or convergence planes, of the plenoptic device sensor. Depending on the nature of the aberration (chromatic and/or geometric) induced by the optical system, light rays focus on different convergence planes when hitting the sensor, as a function of at least one physical and/or geometrical property of the light-field. Such property is therefore considered as a discrimination criterion associated with the aberration induced by the optical system of the plenoptic device, which translates into the light-field data acquired by its sensor. The distance between two consecutive views of a same object dot is referred to under the term “disparity”. Depending on the nature of the aberration (chromatic and/or geometric), this disparity varies as a function of the physical and/or geometrical properties of the light rays captured by the sensor. This “disparity variation”, referred to under the terms “disparity dispersion”, translates into the acquired light-field data the intensity of the aberration induced by the optical system of the plenoptic device.

When implementing the method, the subsets of light-field data are determined as a function of a discrimination criterion associated with the aberration. At least some of these subsets of light-field data are then projected into a two-dimensional picture, also referred to as “sub-picture”, which features a reduced aberration. Such a projection is performed as a function of both the disparity dispersion of the subsets of light-field data and a spatial information on the focalization plane of a corrected picture to be obtained, so that the planes on which the subsets of light-field data are respectively projected and the focalization plane of the corrected picture are as close as possible, and preferentially combined with each other.

By taking advantage of the intrinsic properties of light-field data acquired by a plenoptic device, this post-capture method relies on a new and inventive approach that allows correcting aberration affecting light-field data after their acquisition and without requiring the implementation, within this plenoptic device, of an aberration-free optical system. Consequently, the thickness, weight and complexity of this optical system can be significantly reduced without impacting the quality of the rendered image obtained after correcting and refocusing the light-field data.

In one embodiment, the aberration induced by the main lens of the plenoptic device is a chromatic aberration, and the subsets of light-field data are determined as a function of the wavelength of the light acquired by the sensor.

According to this embodiment, the light rays getting through the main lens are refracted differently as a function of their respective wavelength. Thus, the light rays emitted from a same object point of a scene hit the sensor of the plenoptic device at different localizations, due to the chromatic aberration induced by the main lens. The wavelength of these light rays is therefore the distinctive physical property that is considered when determining the different subsets of the light field data. In the following description, the expression “main lens” refers to an optical system, which receives light from a scene to be captured in an object field of the optical system, and renders the light through the image field of the optical system. In one embodiment of the disclosure, this main lens only includes a single lens. In another embodiment of the disclosure, the main lens comprises a set of lenses mounted one after the other to refract the light of the scene to be captured in the image field.

A method according to this embodiment allows correcting chromatic aberration affecting light-field data.

In one embodiment, the aberration induced by the main lens of the plenoptic device is astigmatism, and the subsets of light-field data are determined as a function of the radial direction in the sensor plane along which light is captured.

According to this embodiment, the light rays getting through the main lens are refracted differently as a function of their radial direction, which is therefore the distinctive geometrical property that is considered when determining the different subsets of the light field data. A method according to this embodiment allows correcting astigmatism affecting light-field data.

In one embodiment, the method comprises determining the disparity dispersion resulting from the light aberration from calibration data of the plenoptic device.

Such calibration data are usually more accurate and specific to a certain camera than datasheets reporting the results of tests run by the manufacturer after assembling the camera or any other camera of the same model.

In one embodiment, the method comprises determining the disparity dispersion resulting from the aberration by analyzing a calibration picture.

By this way, the method allows determining autonomously the aberration affecting the light-field data. Thus, there is no need to provide information about the disparity dispersion other than the one included into the light-field data themselves, and no calibration data is needed.

In one embodiment, light-field data are first focused and analyzed taking the green color as a reference.

Green light has the advantage of featuring a high luminance, while being the color to which human eye is the most sensitive. Alternatively, light-field data may also be focused taking another color as a reference.

In one embodiment, the wavelength of the light acquired by the sensor pertains to a color of a Bayer filter.

A method according to this embodiment is adapted to process light-field data acquired from a plenoptic camera embodying a Bayer filter.

In one embodiment, this method comprises determining 3 (three) subsets of light-field data, each of them corresponding to the captured light rays featuring the wavelength of one of the Bayer filter colors (blue, green, red).

It is therefore possible to rebuild all the colors of the visible spectrum when rendering the corrected image.

The method may also be implemented on light-field data acquired from a plenoptic device embodying another type of Color Filter Array, or whose sensor only detects one wavelength. In such embodiments, more or less subsets of light-field data may be determined, as a function of the discrimination ability of the plenoptic device sensor.

In one embodiment of the method for correcting aberration, the step projecting is done for all of the subsets of light field data.

In one particular embodiment of the technique, an apparatus for correcting aberration affecting light-field data acquired by the sensor of a plenoptic device is disclosed. Such an apparatus comprises a processor configured for:
determining a plurality of subsets of light-field data among said light-field data, as a function of a physical and/or geometrical property of said light-field data, said property being a discrimination criterion associated with said aberration;
projecting at least some of said subsets of light field data into respective refocused sub-pictures, as a function of:
   spatial information about a focalization plane of a corrected picture to be obtained and,
   a respective disparity dispersion resulting from said aberration,
adding said refocused sub-pictures into the corrected picture.

One skilled person will understand that the advantages mentioned in relation with the method described here below also apply to an apparatus that comprises a processor configured for implementing such a method.

The disclosure also pertains to a method of rendering a picture obtained from light-field data acquired by a sensor of a plenoptic device, said method comprising:
determining a plurality of subsets of light-field data among said light-field data, as a function of a physical and/or geometrical property of said light-field data, said property being a discrimination criterion associated with said aberration,
projecting at least some of said subsets of light field data into respective refocused sub-pictures, as a function of:
   spatial information about a focalization plane of a corrected picture to be obtained and,
   a respective disparity dispersion resulting from said aberration,
adding said refocused sub-pictures into the corrected picture.
rendering said corrected picture.

In one embodiment of the method of rendering, the step projecting is done for all of the subsets of light field data.

The disclosure also pertains to a plenoptic device comprising a sensor for acquiring light-field data and a main lens inducing aberration on said light-field data, wherein it comprises a processor configured for:
determining a plurality of subsets of light-field data among said light-field data, as a function of a physical and/or geometrical property of said light-field data, said property being a discrimination criterion associated with said aberration,
projecting at least some of said subsets of light field data into respective refocused sub-pictures, as a function of:
   spatial information about a focalization plane of a corrected picture to be obtained and,
   a respective disparity dispersion resulting from said aberration,
adding said refocused sub-pictures into the corrected picture,
   and wherein it comprises a display for displaying said corrected picture.

Such a plenoptic device is therefore adapted to acquire light-field data and process them in order to display a refocused picture free of aberration. Because the method for correcting aberration is implemented after the acquisition of the light-field data, such a plenoptic camera does not need to implement a main lens adapted to correct independently the aberration. Thus, the thickness, weight and complexity of the plenoptic device main lens can be significantly reduced without impacting the quality of the rendered image obtained after correcting and refocusing the light-field data.

In one embodiment of the plenoptic device, the step projecting is done for all of the subsets of light field data.

In one particular embodiment of the technique, the present disclosure pertains a computer program product downloadable from a communication network and/or recorded on a medium readable by a computer and/or executable by a processor. Such a computer program product comprises program code instructions for implementing at least one of the methods described here below.

In one particular embodiment of the technique, the present disclosure pertains a non-transitory computer-readable carrier medium comprising a computer program product recorded thereon and capable of being run by a processor, including program code instructions for implementing at least one of the methods described here below.

While not explicitly described, the present embodiments may be employed in any combination or sub-combination.

### 4. BRIEF DESCRIPTION OF THE DRAWINGS

The present disclosure can be better understood with reference to the following description and drawings, given by way of example and not limiting the scope of protection, and in which:

FIG. 1 is a schematic representation illustrating a plenoptic camera,

FIG. 2 is a schematic representation illustrating light-field data recorded by a sensor of a plenoptic camera,

FIG. 3 is a schematic representation illustrating a plenoptic camera with W>P,

FIG. 4 is a schematic representation illustrating a plenoptic camera with W<P,

FIG. 5 is a schematic representation of the chromatic aberration phenomenon,

FIG. 6 is a schematic representation illustrating a plenoptic camera,

FIG. 7 is a schematic representation illustrating a light-field data recorded by a sensor of a plenoptic camera, for rays of various wavelengths,

FIG. 8 is a schematic representation of the astigmatism phenomenon,

FIG. 9 is a schematic representation illustrating a light-field data recorded by a sensor of a plenoptic camera, for various radial directions,

FIG. 10 is a flow chart of the successive steps implemented when performing a method according to one embodiment of the disclosure,

FIG. 11 is a flow chart of the successive steps implemented when determining the disparity dispersion according to one embodiment of the disclosure,

FIG. 12 is a flow chart of the successive steps implemented when determining the disparity dispersion according to another embodiment of the disclosure,

FIG. 13 is a schematic view of a light-field data showing a chessboard,

FIG. 14 is a schematic block diagram illustrating an apparatus for correcting light aberration, according to one embodiment of the disclosure.

The components in the Figures are not necessarily to scale, emphasis instead being placed upon illustrating the principles of the disclosure.

### 5. DETAILED DESCRIPTION

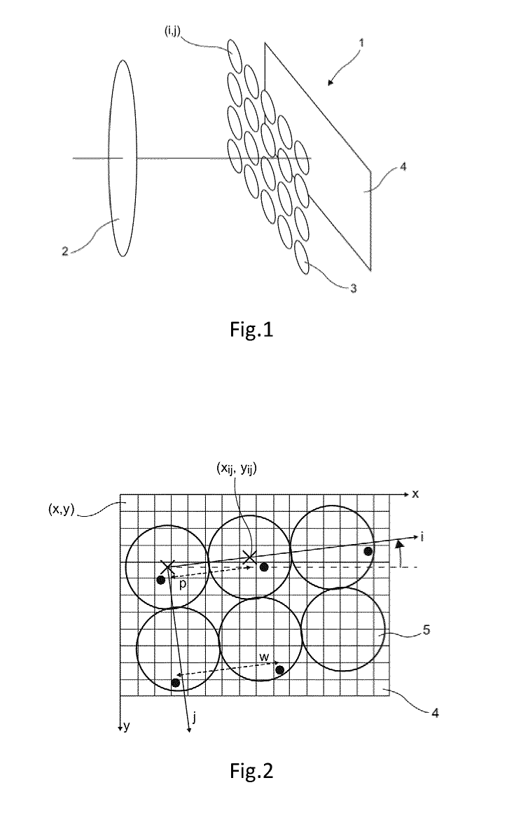

General concepts and specific details of certain embodiments of the disclosure are set forth in the following description and in FIGS. 1 to 11 to provide a thorough understanding of such embodiments. Nevertheless, the present disclosure may have additional embodiments, or may be practiced without several of the details described in the following description.

### 5.1 General Concepts

The invention relies on a new and inventive approach that takes advantage of the intrinsic properties of light-field data acquired by a plenoptic device to allow correcting aberration affecting these light-field data after their acquisition and without requiring the implementation, within this plenoptic device, of an aberration-free optical system. As a consequence, the thickness, weight and complexity of this optical system can be significantly reduced without impacting the quality of a rendered image obtained after correcting and refocusing the light-field.

### 5.1.1 Description of a Plenoptic Camera

FIG. 1 illustrates a schematic plenoptic camera 1 made of a main lens 2, a microlens array 3, and a sensor 4. The main lens 2 receives light from a scene to be captured (not shown) in its object field and renders the light through a microlens array 3, which is positioned on the main lens image field. In one embodiment, this microlens array 3 includes a plurality of circular microlenses arranged in a two-dimensional (2D) array. In another embodiment, such microlenses have different shapes, e.g. elliptical, without departing from the scope of the disclosure. Each microlens has the lens properties to direct the light of a corresponding microimage to a dedicated area on the sensor 4: the sensor microimage 5.

In one embodiment, some spacers are located between the microlens array 3, around each lens, and the sensor 4, to prevent light from one lens to overlap with the light of other lenses at the sensor side.

### 5.1.2 4D Light-Field Data:

The image captured on the sensor 4 is made of a collection of 2D small images arranged within a 2D image. Each small image is produced by the microlens (i, j) from the microlens array 3. FIG. 2 illustrates an example of image recorded by the sensor 4. Each microlens (i,j) produces a microimage represented by a circle (the shape of the small image depends on the shape of the microlenses, which is typically circular). Pixel coordinates are labeled (x, y). p is the distance between two consecutive microimages 5. Microlenses (i, j) are chosen such that p is larger than a pixel size δ. Microlens images areas 5 are referenced by their coordinates (i,j). Some pixels (x,y) might not receive any light from any microlens (i,j); those pixels (x,y) are discarded. Indeed, the inter microlens space is masked out to prevent photons to pass outside from a microlens (if the microlenses have a square shape, no masking is needed). The center (x_{i,j}, y_{i,j}) of a microlens image (i, j) is located on the sensor 4 at the coordinate (x_{i,j}, y_{i,j}). θ is the angle between the square lattice of pixel and the square lattice of microlenses. The (x_{i,j}, y_{i,j}) can be computed by the following equation considering (x_{0,0}, y_{0,0}) the pixel coordinate of the microlens image (0,0):

$$[ \begin{matrix}{x}_{i , j} \\ {y}_{i , j}\end{matrix} ] = p [ \begin{matrix}cos θ & - sin θ \\ sin θ & cos θ\end{matrix} ] [ \begin{matrix}i \\ j\end{matrix} ] + [ \begin{matrix}{x}_{0 , 0} \\ {y}_{0 , 0}\end{matrix} ]$$

This formulation assumes that the microlens array 3 is arranged following a square lattice. However, the present disclosure is not limited to this lattice and applies equally to hexagonal lattice or even non-regular lattices.

FIG. 2 also illustrates that an object from the scene is visible on several contiguous micro-lens images (dark dots). The distance between two consecutive views of an object is w, this distance is also referred to under the term “disparity”. The disparity w depends on the depth of the point in the scene being captured, i.e. the distance between the scene point and the camera. A scene point is visible on r consecutive micro-lens images with:

$$r = \vert \frac{p}{\vert p - w \vert} \vert$$

Where r is the number of consecutive micro-lens images in one dimension. An object is visible in r² micro-lens images. Depending on the shape of the micro-lens image, some of the r² views of the object might be invisible.

### 5.1.3 Optical Property of the Light-Field Camera

The distances p and w introduced in the previous sub-section are given in unit of pixel. They are converted into physical unit distance (meters) respectively P and W by multiplying by the pixel size δ:

W=δw and P=δp

These distances depend on the light-field camera features.

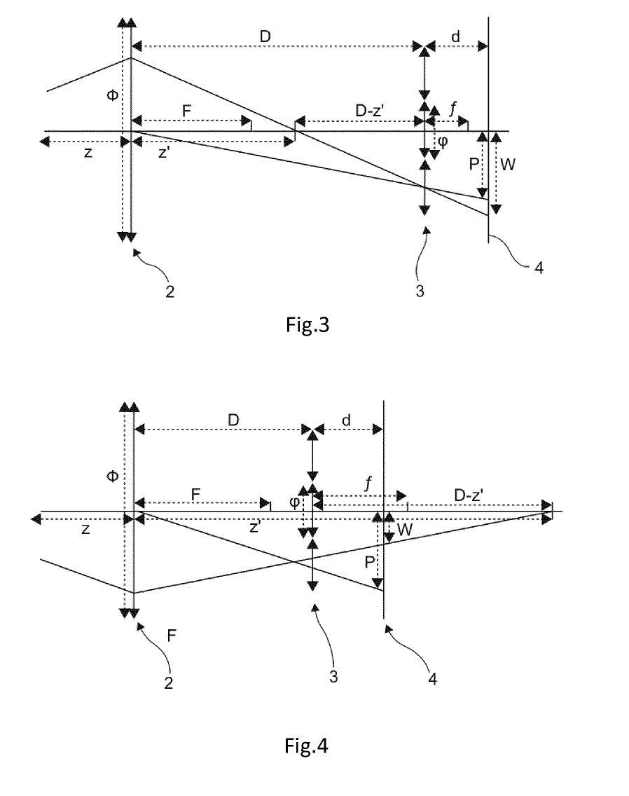

FIG. 3 and FIG. 4 illustrate schematic light-field capture devices, assuming perfect thin lens model. The main-lens has a focal length F and an aperture Φ. The microlens array is made of microlenses having a focal length f. The pitch of the microlens array is ϕ. The microlens array is located at a distance D from the main-lens, and a distance d from the sensor. The object (not visible on the Figures) is located at a distance z from the main-lens (left). This object is focused by the main-lens at a distance z′ from the main-lens (right). FIG. 3 and FIG. 4 illustrate the cases where respectively D is greater and lower than z′. In both cases, microlens images can be in focus depending on d and f.

The disparity W varies with the distance z of the object or scene point from the main lens (object depth). Mathematically from the thin lens equation:

$$\frac{1}{z} + \frac{1}{{z}^{′}} = \frac{1}{F}$$

And Thales law:

$$\frac{D - {z}^{′}}{φ} = \frac{D - {z}^{′} + d}{W}$$

From the two preceding equations, a relationship between the disparity W and depth z of the object in the scene may be deduced as follows:

$$W = φ ( 1 + \frac{d}{D - \frac{zF}{z - F}} ) \qquad ( 1 )$$

The relation between the disparity W of the corresponding views and the depth z of the object in the scene is determined from geometrical considerations and does not assume that the micro-lens images are in focus.

The disparity of an object which is observed in focus is given as: W_{focus}=ϕd/f

In practice micro-lens images may be tuned to be in focus by adjusting parameters d and D according to the thin lens equation:

$$\frac{1}{D - {z}^{′}} + \frac{1}{d} = \frac{1}{f}$$

A micro lens image observed on a photo sensor of an object located at a distance z from the main lens appears in focus as long as the circle of confusion is smaller than the pixel size. In practice the range [Zm, ZM] of distances z, which enables micro images to be observed in focus is large and may be optimized depending on the focal length f, the apertures of the mains lens and the microlenses and the distances D and d.

From the Thales law P may be derived

$$e = \frac{D + d}{D}$$

$$P = φ e$$

The ratio e defines the enlargement between the micro-lens pitch and the pitch of the micro-lens images projected on the photosensor. This ratio is typically close to 1 since d is negligible compared to D.

### 5.1.4 Image Re-Focusing

A major property of the light-field camera is the possibility to compute 2D re-focused images where the re-focalization distance is freely adjustable. The 4D light-field data is projected into a 2D image by just shifting and zooming on micro-lens images and then summing them into a 2D image. The amount of shift controls the re-focalization distance. The projection of the 4D light-field pixel (x, y, i, j) into the re-focused 2D image coordinate (X, Y) is defined by:

$$[ \begin{matrix}X \\ Y\end{matrix} ] = sg ( [ \begin{matrix}x \\ y\end{matrix} ] - [ \begin{matrix}{x}_{i , j} \\ {y}_{i , j}\end{matrix} ] ) + s [ \begin{matrix}{x}_{i , j} \\ {y}_{i , j}\end{matrix} ]$$

Where s controls the size of the 2D re-focused image, and g controls the focalization distance of the re-focused image. The equation can be written as follow:

$$[ \begin{matrix}X \\ Y\end{matrix} ] = sg [ \begin{matrix}x \\ y\end{matrix} ] + sp ( 1 - g ) [ \begin{matrix}cos θ & - sin θ \\ sin θ & cos θ\end{matrix} ] [ \begin{matrix}i \\ j\end{matrix} ] + s ( 1 - g ) [ \begin{matrix}{x}_{0 , 0} \\ {y}_{0 , 0}\end{matrix} ]$$

The parameter g can be expressed as a function of p and w. g is the zoom that must be performed on the micro-lens images, using their centers as reference, such that the various zoomed views of the same objects gets superposed. One obtains:

$$g = \frac{p}{p - w}$$

The equation becomes:

$$[ \begin{matrix}X \\ Y\end{matrix} ] = sg [ \begin{matrix}x \\ y\end{matrix} ] - sgw [ \begin{matrix}cos θ & - sin θ \\ sin θ & cos θ\end{matrix} ] [ \begin{matrix}i \\ j\end{matrix} ] + \frac{sgw}{p} [ \begin{matrix}{x}_{0 , 0} \\ {y}_{0 , 0}\end{matrix} ] \qquad ( 2 )$$

Image refocusing consists in projecting the light-field pixels L(x, y, i, j) recorded by the sensor into a 2D refocused image of coordinate (X, Y). The projection is performed according to the equation (2). The value of the light-field pixel L(x, y, i, j) is added on the refocused image at coordinate (X, Y). If the projected coordinate is non-integer, the pixel is added using interpolation. To record the number of pixels projected into the refocus image, a weight-map image having the same size as the refocus image is created. This image is preliminary set to 0. For each light-field pixel projected on the refocused image, the value of 1.0 is added to the weight-map at the coordinate (X, Y). If interpolation is used, the same interpolation kernel is used for both the refocused and the weight-map images. After all the light-field pixels are projected, the refocused image is divided pixel per pixel by the weight-map image. This normalization step, ensures brightness consistency of the normalized refocused image.

### 5.1.5 Chromatic Aberration Issue

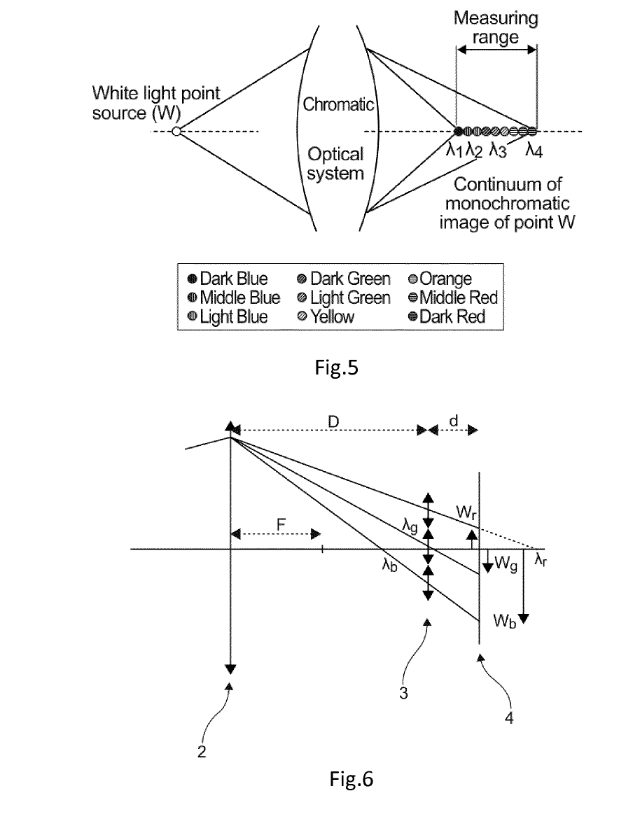

As illustrated by FIG. 5, the chromatic aberration issue comes from lens imperfections, which prevents focusing all colors of an object dot in the same image plane.

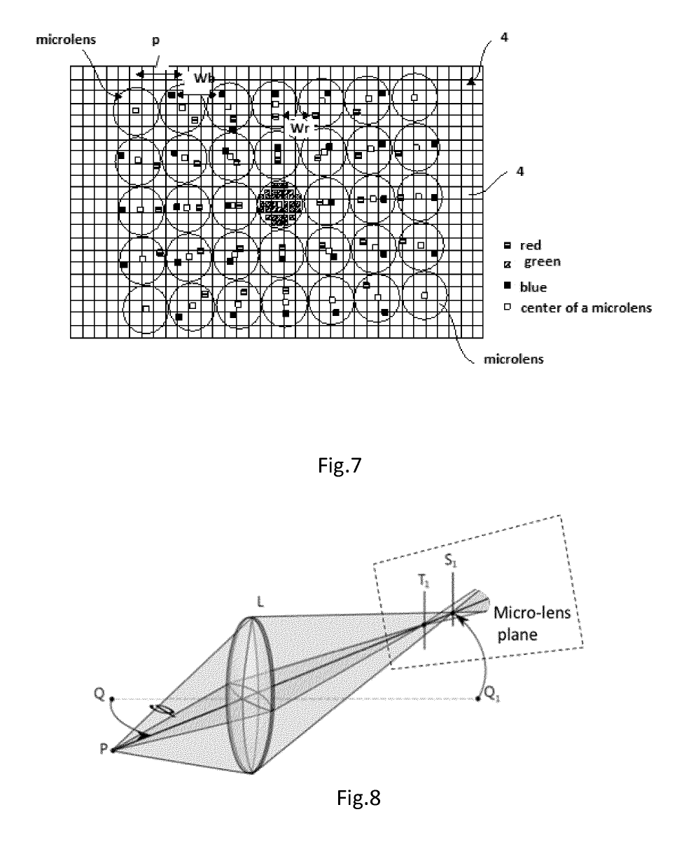

When studying the impact of chromatic aberration in a plenoptic camera system as illustrated by FIG. 6 and FIG. 7, it has been observed that the variation of convergence plane depending on the wavelength translates into a variation of the disparity W also depending on the wavelength. The light-field as illustrated by these Figures is focused on the green color (G,λ_{g}), whose object dot is therefore imaged under one microlens (i,j), positioned at the center of the sensor 4 of FIG. 7, as a matter of illustration. In contrast, the blue and red images of the same object dot are respectively formed before and after the sensor plane. As a consequence, the corresponding blue (B,λ_{g}) and red (R,λᵣ) light rays are not only refracted by the central microlens but also by the surrounding microlenses. By this way, blue and red light rays coming from the object dot are captured on a plurality of microimages 5, with a specific disparity (W_{b}, W_{g}, Wᵣ) defined as a function of their wavelength.

### 5.1.6 Astigmatism Issue

As illustrated by FIG. 8, astigmatism is a geometric aberration issues occurring when the main lens of the plenoptic camera is not symmetric about the optical axis. In this case, the rays coming from an object dot and propagating in the tangential plane and the sagittal plane of the main lens converge in different planes.

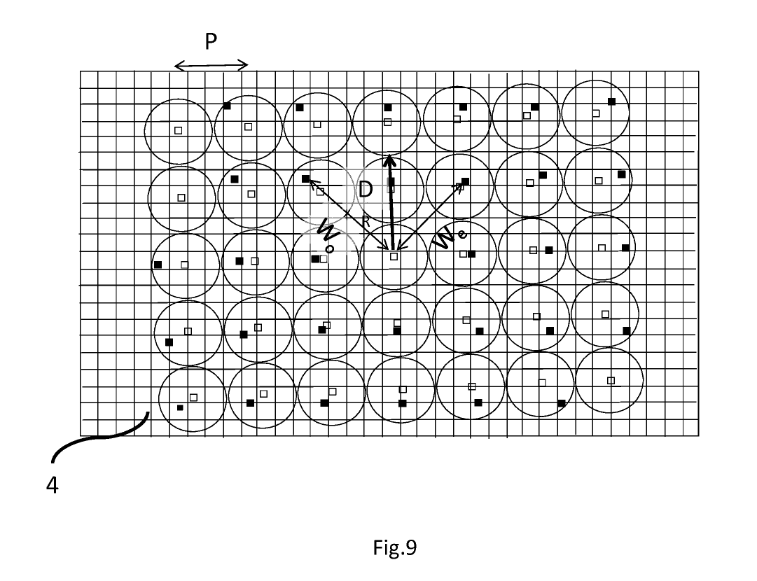

When studying the impact of astigmatism in a plenoptic camera system, as illustrated by FIG. 9, it has been observed that the variation of the radial direction D_{R} in the sensor plane along which light rays are propagating translates into a variation of the disparity W also depending on this radial direction D_{R}, and varying between a maximum value W_{O} and a minimum value Wₑ.

### 5.2 Description of a Method for Correcting Chromatic Aberration

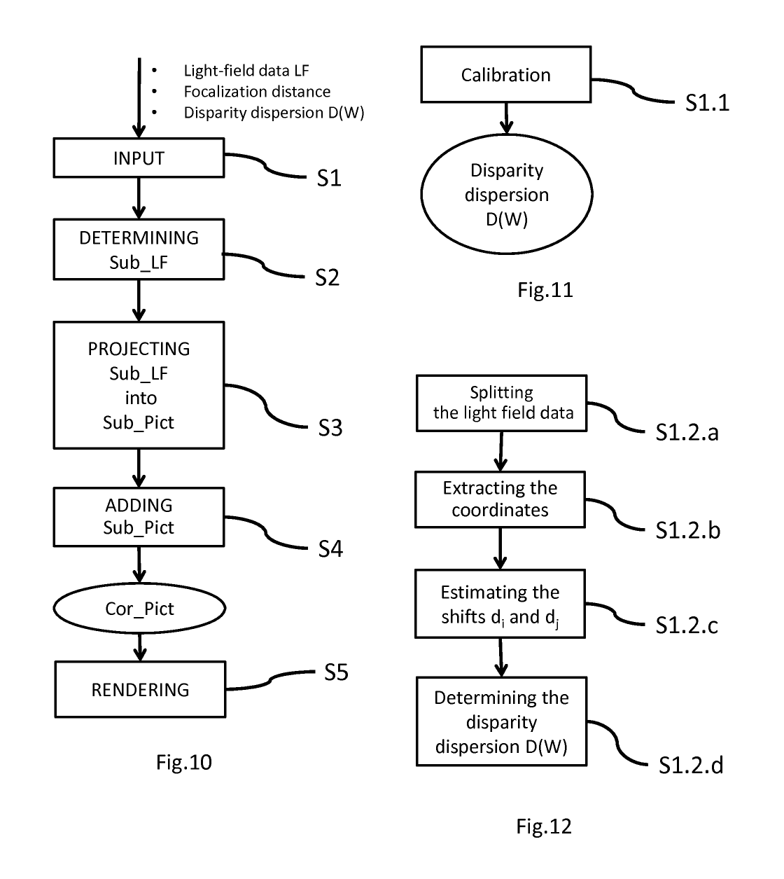

FIG. 10 illustrates in more details the successive steps implemented by a method for correcting chromatic aberration affecting light-field data (LF), according to one embodiment of the disclosure.

After an initialization step, a plurality of data, comprising at least the following data is inputted (step INPUT (S1)):
light-field data (LF) acquired by the sensor 4 of a plenoptic device 1,
spatial information about the focalization plane of a picture (Cor_Pict) to be obtained from the light-field data (LF), for example the focalization distance of said picture (Cor_Pict),
disparity dispersion (D(W)) resulting from the chromatic aberration induced by the main lens 2 of the plenoptic device.

This step INPUT (S1) may be conducted either automatically or by an operator.

The light-field data (LF) may be inputted in any readable format. In a similar way, spatial information about the focalization plane of the picture (Cor_Pict) to be obtained from the light-field data (LF) may be expressed in any spatial referential system. In one embodiment, this focalization plane is determined manually, or semi-manually, following the selection by an operator of one or several objects of interest, within the scene depicted by the light-field. In another embodiment, the focalization plane is determined automatically following the detection within the inputted light-field of objects of interest.

### 5.2.1 Estimating the Disparity Dispersion D(W)

In one embodiment of the invention, the disparity dispersion (D(W)) of the plenoptic device main lens 2 is inputted under the form of datasheets listing the variation of disparity W as a function of the wavelength of the light ray captured by the sensor 4, or providing any other information from which such variations is deductible. In one embodiment, as illustrated by FIG. 11, these datasheets relate to calibration data, which are determined and inputted following the implementation of a calibration step (S1.1), for example performed by the user, prior to using the plenoptic device, or by the manufacturer of the plenoptic device.

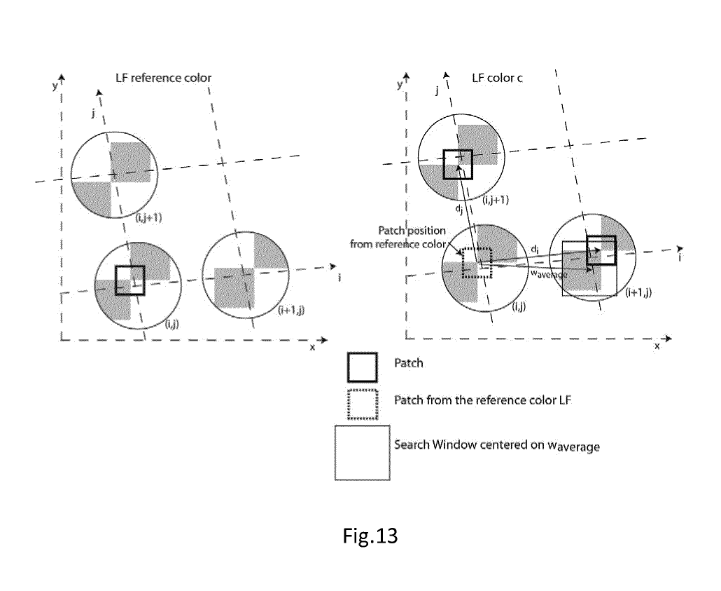

In another embodiment, the disparity dispersion (D(W)) is determined based on the analysis of a calibration picture, as illustrated by FIG. 12 and FIG. 13.

According to equation (1), for a given focalization distance z, the disparity w is assumed constant. In equation (2) the term w is multiplied linearly by

$$[ \begin{matrix}i \\ j\end{matrix} ] .$$

Since the disparity w is not a linear function considering the chromatic aberrations, the term w from equation (2) is replaced by w_{c}(i, j) which indicates the shift in pixels (2D coordinates) associated with micro-image (i, j) where the number of colors ranges from one to a number N_{c} and where c is the color index captured by the sensor (for a Bayer color pattern made of Red, Green and Blue colors, the number N_{c} being equal to three). The disparity w_{c}(i, j) is the 2D pixel shift to perform to match a detail observed on micro-lens (0,0) for a reference color versus the same detail observed at micro-lens (i, j) for color c. If no chromatic aberrations are considered, then:

$${w}_{c} ( i , j ) = w [ \begin{matrix}i \\ j\end{matrix} ] .$$

Considering the disparity w_{c}(i, j), equation (1) becomes:

$$[ \begin{matrix}X \\ Y\end{matrix} ] = sg [ \begin{matrix}x \\ y\end{matrix} ] - {sgw}_{c} ( i , j ) \qquad ( 3 )$$

For a given focalization distance z one can estimate an average w_{average} using a calibration image made of a single dark dot within a white board. That dot is observed on certain consecutive micro-images. The distance between two observations of the dark dots between two consecutive horizontal micro-images gives us an indication of the average w_{average}.

For a given focalization distance z one can estimate the disparity w_{c}(i, j) using a calibration image, as for instance a chessboard located at a focalization distance z from the camera, illustrated by FIG. 12. One color c is used as reference for the other colors. In practice the green is used as reference as it has the advantage of featuring a high luminance, while being the color to which human eye is the most sensitive. The reference color is used to compute the disparity w_{c}(i, j) by running the following steps:
Splitting (step S1.2.a) the light-field data into N_{c} gray level light-fields: the light-field image captured by the sensor is split into the three colors of the Bayer pattern. For each light-field LF_{c} associated with a color c, the pixels with no values (covered by another colors from the Bayer pattern) are estimated for instance using linear interpolation with the neighborhood pixels. The number N_{c} of completed light-fields LF_{c} are computed, one for each color c. In another embodiment, other demosaicing techniques known from one skilled in the art can be used to achieve the same result.
Extracting (step S1.2.b) the coordinate of the chessboard: the intersection between 2 black squares of the chessboard observed in the micro-images are detected using a corner detection algorithm like the well-known Harris corner detection described in the article “A combined corner and edge detector”, C. Harris and M. Stephens (1988), Proceedings of the 4th Alvey Vision Conference. p. 147-151.
Estimating (step S1.2.c) the shifts (dᵢ, dⱼ) between consecutive micro-images: the light-field LF_{c} associated with color c is showing the chessboard as illustrated in FIG. 13. One focuses on the intersection between two black squares of the chessboard, which are observed on several consecutive micro-images. Estimating the 2D pixel shift between two intersections can be performed using patches extracted from one micro-image (i,j) from the light-field LF_{ref} observed with the reference color (according to corner extracted in the previous step), and the next micro-image on the right (i+1,j) from the light-field LF_{c}, or one the next micro-image on the top (i,j+1) from the light-field LF_{c}. Between micro-images (i,j) and (i+1,j), the shift dᵢ is estimated using patch-based cross-correlation method:
   A patch P_{ref} of N×N pixels (with for instance N equal to 31 for a precise estimation) is extracted around intersection pixel at coordinate (α, β) (given form extracted chessboard coordinates from previous step) from micro-image (i,j) from the light-field LF_{ref}.
   Patches P_{a,b} of the same size if extracted from the micro-image (i+1, j) from the light-field LF_{c} centered on pixel (α+w_{average}+α, β+b). Where (a, b) are integers such that (a, b)∈[−S,S]² where S defines the radius of a window search which should encompass the variation of disparity w. S is typically equal to couple of pixels, which corresponds to the typical variation of disparity w_{c}(i,j).
   The Sum of Absolute Difference (SAD) or the Sum of Square Difference (SSD) is computed between reference patch P_{ref} and the patches P_{a,b}. The SAD or SSD have a minimum value for a given patch position (a, b). (a, b) indicates the local shift dᵢ between the micro-image (i,j) from the light-field LF_{ref} and the micro-image (i+1,j) from the light-field LF_{c}. By construction:

dᵢ=w_{c}(i+1,j)−w_{ref}(i,j)
Identically the shift dᵢ is computed between the micro-image (i, j) from the light-field LF_{ref} and the micro-image (i, j+1) from the light-field LF_{c}.
Determining (step S1.2.d) the shift or disparity dispersion D(W_{C}(i, j)) for any micro-lens of the light-field LF_{c}, versus the micro-lens (0,0) of the light-field LF_{ref}.
   The previous procedure is repeated for the N_{c} colors recorded by the sensor. Knowing the disparity dispersion D(W_{C} (i, j)) of each light-field LF_{c} and therefore, all the values of the disparity w_{c}(i, j), equation (2) can be used to compute refocused images with corrected chromatic aberrations.

### 5.2.2 Running the Method for Correcting Chromatic Aberration

Following the step INPUT (S1), a plurality of subsets of light-field data (sub_LF) is determined (step S2), as a function of the wavelength of the captured light rays. In this embodiment, a Bayer Color Filter Array is mounted on the sensor 4 of the plenoptic device 1 used to acquire the processed light-field data (LF). Therefore, 3 (three) subsets of light-field data (sub_LF) are determined (S2), each of them corresponding to the captured light rays featuring the wavelength of one of the Bayer filter colors (blue, green, red). The wavelength of these light rays is therefore the distinctive physical property considered when determining the different subsets of the light field data. In another embodiment, the method may also be implemented on light-field data acquired from a plenoptic device embodying another type of Color Filter Array, or whose sensor only detects one wavelength. In such embodiments, more or less subsets of light-field data (sub_LF) may be determined (S2), as a function of the detection ability of the plenoptic device sensor 4.

At the step Projecting (S3), at least some of the determined subsets of light-field data (sub_LF) are selected. Then, each of these selected subsets of light-field data (sub_LF) is projected into a respective two-dimensional sub-picture (sub_Pict) with corrected chromatic aberrations, using the equation (2) described here before in paragraph 5.1.4. In particular, when running this equation (2), the focalization distance of the sub-picture, controlled by g, is determined as a function of the focalization distance of the corrected picture (Cor_Pict) to be obtained, so that these two focalization distances are as close as possible, and preferentially equal to each other. In parallel, the disparity w to apply in the equation (2) is determined as a function the disparity dispersion D(W) of the subsets of light-field data (sub_LF), as described in paragraph 5.2.1.

Following the projection step (S3), the 3 (three) sub-pictures (sub_Pict) are summed up (S4) (or added) and therefore a colored two-dimensional picture (Cor_Pict) is obtained. In a preferential embodiment of the invention, each of the two-dimensional sub-picture (sub_Pict) is included into the focalization plane of the two-dimensional picture (Cor_Pict) to be obtained. Thus, this colored picture (Cor_Pict) is free of chromatic aberration since all the light-rays of the light-field converge into the focalization plane of the corrected picture (Cor_Pict) whatever their wavelength.

In another embodiment of the invention, at least one of the sub-picture (sub_Pict) is misaligned with the focalization plane of the corrected picture (Cor_Pict). As a consequence, a chromatic aberration of the color depicted by said sub-picture (sub_Pict) might remain on the corrected picture (Cor_Pict), the intensity of the aberration decreasing when the sub-picture (sub_Pict) is getting closer to the focalization plane of the corrected picture (Cor_Pict).

In another embodiment of the disclosure, the plenoptic camera does not comprise a color filter array (such as a Bayer filter, and so on) that induces the use of a demosaicing method for generating monochromatic subsets of light field data. For example, in one embodiment, the plenoptic camera uses an array of Foveon X3 sensors (such kind of sensors are described in the article entitled “Comparison of color demosaicing methods” by Olivier Losson et al.), or other sensors that are enabled to record red, green, and blue light at each point in an image during a single exposure. In such case, no demosaicing method for generating monochromatic subsets of light field data is implemented.

### 5.3 Description of a Method for Correcting Astigmatism

The method for correcting chromatic aberration, as described here below in paragraph 5.2, may be applied to the correction of geometrical aberration and especially astigmatism, with the only differences being that:
the disparity dispersion (D(W)) varies as a function of a radial direction (D_{R}) in the sensor plane along which light rays are captured,
subsets of light-fields (sub_LF) are determined (S2) as a function of the radial direction (D_{R}).

In one embodiment, 16 (sixteen) subsets of light-fields (sub_LF) are determined (S2), based on the assumption that only the microimages 5 located in a close neighborhood of the central microimage are affected by astigmatism.

Nevertheless, in other embodiments, less or more subsets of light-fields (for example: 8 (eight), or 32 (thirty-two)) may be projected depending on the desired accuracy of astigmatism correction and on the available calculation resources.

In one embodiment, the method comprises interpolating the subsets of light-fields (sub_LF) in order to re-build the missing data.

In one embodiment, the method comprises rendering (S5) the corrected picture (Cor_Pict).

### 5.4 Description of an Apparatus for Correcting Aberration Affecting Light-Field Data.

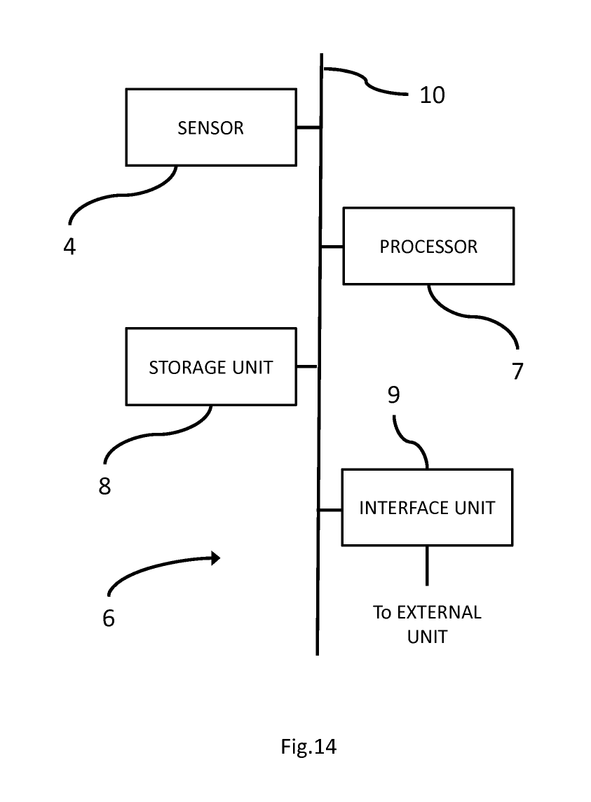

FIG. 14 is a schematic block diagram illustrating an example of an apparatus 6 for correcting aberration affecting light-field data, according to one embodiment of the present disclosure. Such an apparatus 6 includes a processor 7, a storage unit 8, an interface unit 9 and a sensor 4, which are connected by a bus 10. Of course, constituent elements of the computer apparatus 6 may be connected by a connection other than a bus connection using the bus 10.

The processor 7 controls operations of the apparatus 6. The storage unit 8 stores at least one program to be executed by the processor 7, and various data, including light-field data, parameters used by computations performed by the processor 7, intermediate data of computations performed by the processor 7, and so on. The processor 7 may be formed by any known and suitable hardware, or software, or by a combination of hardware and software. For example, the processor 7 may be formed by dedicated hardware such as a processing circuit, or by a programmable processing unit such as a CPU (Central Processing Unit) that executes a program stored in a memory thereof.

The storage unit 8 may be formed by any suitable storage or means capable of storing the program, data, or the like in a computer-readable manner. Examples of the storage unit 8 include non-transitory computer-readable storage media such as semiconductor memory devices, and magnetic, optical, or magneto-optical recording media loaded into a read and write unit. The program causes the processor 7 to perform a process for correcting aberration affecting light-field data, according to an embodiment of the present disclosure as described above with reference to FIG. 10.

The interface unit 9 provides an interface between the apparatus 6 and an external apparatus. The interface unit 9 may be in communication with the external apparatus via cable or wireless communication. In this embodiment, the external apparatus may be a plenoptic camera 1. In this case, light-field data can be input from the plenoptic camera 1 to the apparatus 6 through the interface unit 9, and then stored in the storage unit 8.

The apparatus 6 and the plenoptic camera 1 may communicate with each other via cable or wireless communication.

Alternatively, the apparatus 6 may be integrated into a plenoptic camera 1 comprising a display for displaying the corrected picture (Cor_Pict).

Although only one processor 7 is shown on FIG. 14, a skilled person will understand that such a processor may comprise different modules and units embodying the functions carried out by the apparatus 6 according to embodiments of the present disclosure, such as:
A module for determining (S2) a plurality of subsets of light-field data (Sub_LF) among said light-field data (LF), as a function of a physical and/or geometrical property of said light-field data,
A module for projecting (S3) at least some of said subsets of light field data (Sub_LF) into respective refocused sub-pictures (Sub_Pict), as a function of:
   spatial information about a focalization plane of a corrected picture (Cor_Pict) to be obtained and,
   a respective disparity dispersion (D(W)) resulting from said aberration,
A module for adding (S4) said sub-pictures (Sub_Pict) into the corrected picture (Cor_Pict).

These modules may also be embodied in several processors 9 communicating and co-operating with each other.

As will be appreciated by one skilled in the art, aspects of the present principles can be embodied as a system, method or computer readable medium. Accordingly, aspects of the present principles can take the form of an entirely hardware embodiment, an entirely software embodiment (including firmware, resident software, microcode, and so forth), or an embodiment combining software and hardware aspects.

When the present principles are implemented by one or several hardware components, it can be noted that a hardware component comprises a processor that is an integrated circuit such as a central processing unit, and/or a microprocessor, and/or an Application-specific integrated circuit (ASIC), and/or an Application-specific instruction-set processor (ASIP), and/or a graphics processing unit (GPU), and/or a physics processing unit (PPU), and/or a digital signal processor (DSP), and/or an image processor, and/or a coprocessor, and/or a floating-point unit, and/or a network processor, and/or an audio processor, and/or a multi-core processor. Moreover, the hardware component can also comprise a baseband processor (comprising for example memory units, and a firmware) and/or radio electronic circuits (that can comprise antennas), which receive or transmit radio signals. In one embodiment, the hardware component is compliant with one or more standards such as ISO/IEC 18092/ECMA-340, ISO/IEC 21481/ECMA-352, GSMA, StoLPaN, ETSI/SCP (Smart Card Platform), GlobalPlatform (i.e. a secure element). In a variant, the hardware component is a Radio-frequency identification (RFID) tag. In one embodiment, a hardware component comprises circuits that enable Bluetooth communications, and/or Wi-fi communications, and/or Zigbee communications, and/or USB communications and/or Firewire communications and/or NFC (for Near Field) communications.

Furthermore, aspects of the present principles can take the form of a computer readable storage medium. Any combination of one or more computer readable storage medium(s) may be utilized.

Thus for example, it will be appreciated that any flow charts, flow diagrams, state transition diagrams, pseudo code, and the like represent various processes which may be substantially represented in computer readable storage media and so executed by a computer or a processor, whether or not such computer or processor is explicitly shown.

Although the present disclosure has been described with reference to one or more examples, a skilled person will recognize that changes may be made in form and detail without departing from the scope of the disclosure and/or the appended claims.

1. Method for correcting aberration affecting light-field data acquired by a sensor of a plenoptic device,
wherein said method comprises:
determining a plurality of subsets of light-field data among said light-field data, as a function of a physical and/or geometrical property of said light-field data, said property being a discrimination criterion associated with said aberration,
projecting at least some of said subsets of light field data into respective refocused sub-pictures, as a function of:
spatial information about a focalization plane and,
a respective disparity dispersion resulting from said aberration,
obtaining a corrected picture from a sum of said refocused sub-pictures into a.

2. The method of claim 1, wherein said aberration is chromatic aberration induced by a main lens of said plenoptic device, and wherein said physical property of said light-field data is a wavelength of the light acquired by said sensor.

3. The method of claim 1, wherein said aberration is astigmatism induced by a main lens of said plenoptic device, and wherein said geometrical property of said light-field data is a radial direction in the sensor plane along which light is captured.

4. The method of claim 1, wherein it comprises determining the disparity dispersion resulting from said aberration from calibration data of said plenoptic device.

5. The method of claim 1, wherein it comprises determining the disparity dispersion resulting from said aberration by analyzing a calibration picture.

6. The method of claim 2, wherein the wavelength of the light acquired by the sensor pertains to a color of a Bayer filter.

7. The method of claim 1, wherein said projecting is done for all of said subsets of light field data.

8. An apparatus for correcting aberration affecting light-field data acquired by a sensor of a plenoptic device,
said apparatus comprising a memory and at least one processor, coupled to said memory, wherein said at least one processor is configured to:
determine a plurality of subsets of light-field data among said light-field data, as a function of a physical and/or geometrical property of said light-field data, said property being a discrimination criterion associated with said aberration,
project at least some of said subsets of light field data into respective refocused sub-pictures, as a function of:
spatial information about a focalization plane and,
a respective disparity dispersion resulting from said aberration,
obtain a corrected picture from a sum of said refocused sub-pictures.

9. A computer program product downloadable from a communication network and/or recorded on a medium readable by a computer and/or executable by a processor, comprising program code instructions for implementing a method according to claim 1.

10. A non-transitory computer-readable carrier medium comprising a computer program product recorded thereon and capable of being run by a processor, including program code instructions for implementing a method according to claim 1.

11. A method of rendering a picture obtained from light-field data acquired by a sensor of a plenoptic device, wherein said method comprises:
determining a plurality of subsets of light-field data among said light-field data, as a function of a physical and/or geometrical property of said light-field data, said property being a discrimination criterion associated with said aberration,
projecting at least some of said subsets of light field data into respective refocused sub-pictures, as a function of:
spatial information about a focalization plane,
a respective disparity dispersion resulting from said aberration,
obtaining a corrected picture from a sum of said refocused sub-pictures; and
rendering said corrected picture.

12. The method of claim 11, wherein said projecting is done for all of said subsets of light field data.

13. A plenoptic device comprising a sensor for acquiring light-field data and a main lens inducing aberration on said light-field data, wherein it comprises a memory and a processor coupled to said memory, wherein said processor is configured to:
determine a plurality of subsets of light-field data among said light-field data, as a function of a physical and/or geometrical property of said light-field data, said property being a discrimination criterion associated with said aberration,
project at least some of said subsets of light field data into respective refocused sub-pictures, as a function of:
spatial information about a focalization plane and,
a respective disparity dispersion resulting from said aberration,
obtain a corrected picture from a sum of said refocused sub-pictures,
and wherein it comprises a display for displaying said corrected picture.

14. The plenoptic device of claim 13, wherein said processor performs said projection S3 for all of said subsets of light field data.
